(19) United States
(12) Patent Application Publication
(10) Pub. No.: US 2003/0015471 A1
(43) Pub. Date: Jan. 23, 2003

(54) Reverse osmosis device

(76) Inventors: Dietrich Reichwein, Zell am See (AT); Olaf Peters, Dellach/Drau (AT)

Correspondence Address: BRINKS HOFER GILSON & LIONE, ONE INDIANA SQUARE, SUITE 1600, INDIANAPOLIS, IN, 46204-2033, US

(21) Appl. No.: 09/909,373

(22) Filed: Jul. 19, 2001

(51) Int. Cl. B01D 61/02

(52) U.S. Cl. 210/652; 210/321.6

(57) ABSTRACT

A reverse osmosis of a medium to be separated with a reverse osmosis device having a pressure side and a product side, both sides separated by a semipermeable membrane, wherein the medium to be separated can have pressure applied to it on the pressure side by means of a pressure generation appliance including a pressure-condensed working medium which has a critical temperature between 20° and 110° C., in which a pressure increase and volume increase can be generated by heating to apply to the medium to be separated.

The present invention relates to a device for carrying out a membrane separation process such as reverse osmosis, operated by hydrostatic pressure. Membrane filtration methods of this type are based on the utilisation of a semipermeable membrane, the reversal of the normal osmosis being forced by overcoming the osmotic pressure through higher pressure. Here, on the pressure side, high pressure is applied to the medium, usually a liquid such as salt water and the like, which is to be separated from its constituents, such that the molecules of the medium are forced through the semi-permeable membrane against the osmotic pressure. The technical membrane arrangement takes place for example in modules, for example plate, coil, pipe, capillary or hollow fibre modules being used.

Reverse osmosis devices of this type are used on a large scale in obtaining drinking water through seawater desalination and through the renovation of brackish water, in the detoxication and recycling of liquid waste, for example from electroplating plants, in the removal of dyestuffs from liquid waste from textile dyeing or in the treatment of boiler-feed water in the recovery of high-purity water e.g. for the electrical industry and chemical laboratories and in the pharmaceutical and cosmetic industries. There are also applications in the domain of the food industry, for example in the concentration of fruit juices.

Reverse osmosis devices require the generation of high pressure in order to compensate for the osmotic pressure at the semi-permeable membrane. Traditional methods require here high energy input.

The present invention sets itself the task of making available a device for carrying out reverse osmosis, in which the necessary pressure can be generated with low energy requirements.

This task is accomplished by the device according to patent claim 1 and the method according to patent claim 19. Advantageous developments of this device and this method and applications of these methods and devices are given in the further claims.

The present invention is suitable in particular for a desalination plant utilising solar energy to generate pressure by means of a cyclic process. The reverse osmosis device, for example the module which contains the semi-permeable membrane, can be of any conventional construction, such as the large number of such reverse osmosis modules which are commercially available.

Crucial for the present invention is here the recognition that the pressure generation can take place by means of a pressure-condensed working medium. If the latter has a critical temperature between 20 and 100° C., in the region around the critical temperature very strong pressure increase and volume increase of the working medium take place on heating. This pressure increase and volume increase, which are already produced by heating the working medium by a few degrees Celsius, is sufficient to apply to the medium to be separated an adequate pressure for carrying out the reverse osmosis.

Thus for example in heating pressure-condensed CO₂ from 25° C. to 55° C., a 2.3-fold volume increase ensues with a rise in pressure from 65.6 kg/cm² to 100 kg/cm². By means of this pressure, the medium to be separated can now be pumped under high pressure to the semi-permeable membrane.

Advantageously the necessary heat for heating up the working medium can be generated by using solar energy. Particularly suitable for this are of course simply constructed, low-cost and low-maintenance solar collectors. Every other possible way of producing solar energy, for example via solar cells and the generation of electrical current, is however also suitable, but less energy-efficient.

Advantageously a reciprocating engine is used to transfer the pressure of the working medium, which is present as a cylinder filling, to the medium to be separated. Essential here is the choice of the expansion volume which is determined not only by the size of the piston cylinder and the size of the piston but it is also possible to connect the interior volume of the cylinder via a connecting line to a reservoir of working medium. In this case it is sufficient to heat the working medium located in the reservoir so that this medium streams into the cylinder and there exercises pressure on the piston.

In these advantageous variants, the invention is based first of all on the combination of solar heat pressure generation with a reverse osmosis device and on the determination of the piston stroke through the choice of the expansion volume of the working medium in relation to the effective piston surface via possibly additional working medium reservoirs.

The energy requirements are advantageously covered by an efficient heat engine working periodically and having efficient liquid/solid heat carriers. In a similar manner similar to the cyclic process according to Stirling, the working medium itself is not exchanged periodically. Instead of this, a heat flow is led from heating bath T₁ through the working medium periodically alternating to heating bath T₂. Consequently the work available is determined with the thermal efficiency (T₁ T₂)/T₁. In a preferred manner, CO₂ is used in liquid state as the working medium. In principle also working media such as those listed in DE 25 25 534 C3 and DE 23 58 959 C3, can be used in the cyclic process.

Since however the expansion in the liquid state is limited according to the respective physical characteristics, advantageously according to the invention the volume of the working medium is so selected, that in the boundaries from T₁ to T₂ or respectively T₂ to T₁, the volume alteration occurring produces the required piston path in coordination with the piston surface. The piston cross-section is determined by the piston force respectively required.

Periodically operating heat engines having a cyclic process according to Kirchhoff (see DE 25 25 534) have low thermal efficiency on account of the narrow boundaries and low temperature differences between T₂ and T₁, and furthermore on account of the limited heat exchange speed, they also have low working speeds, so that their use can only be justified technically or economically when waste heat or free solar energy is used.

In connection with reverse osmosis systems, solar energy which is available free of charge suggests itself. The low efficiency is compensated by corresponding dimensioning of the absorber surface (collector surfaces). Since only static pressures are required, allowance can be made for the low operating speed through additional pumping devices connected in parallel.

Some examples of devices according to the invention and process management systems according to the invention are described below.

The figures show:

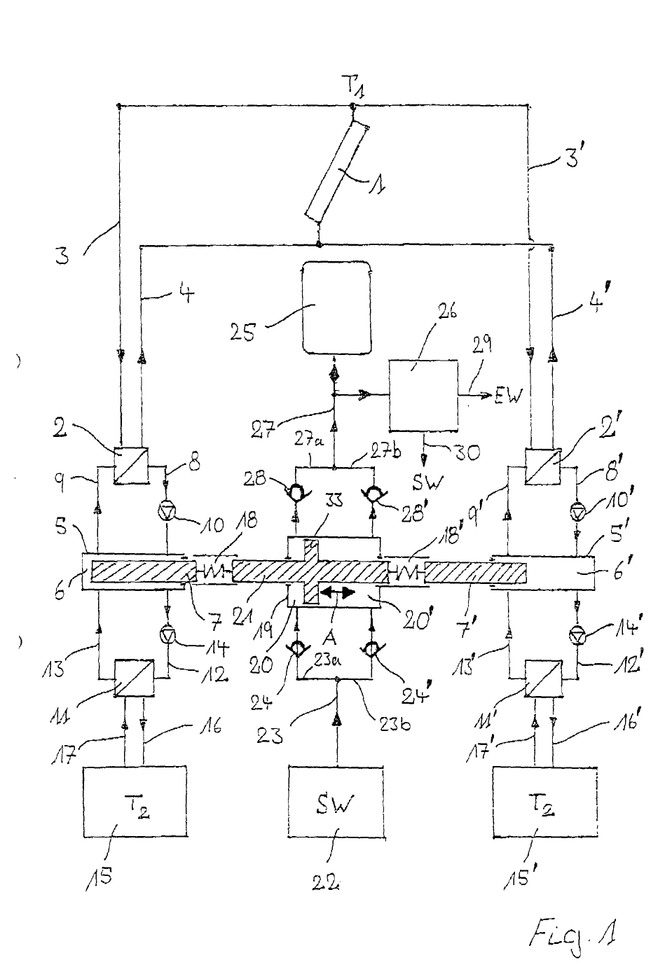

FIG. 1 a preferred embodiment of the present invention;

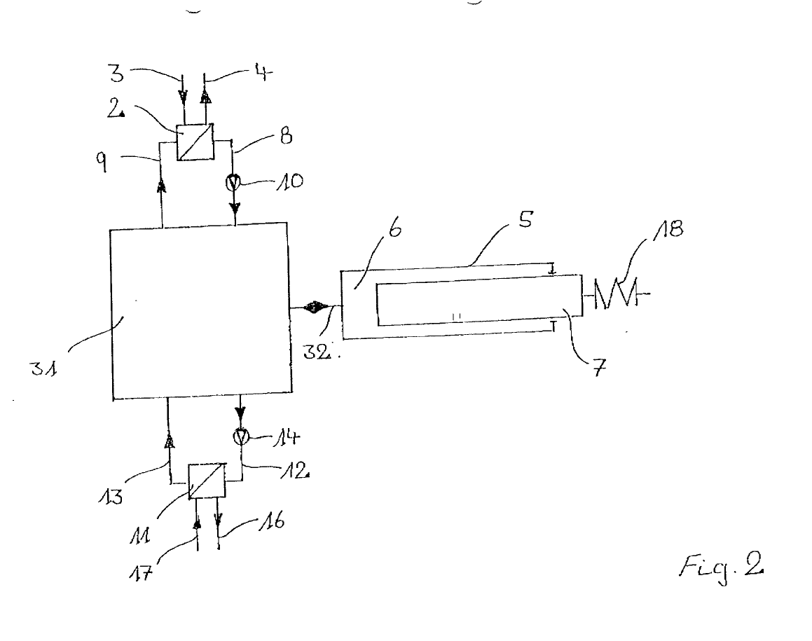

FIG. 2 a variant of the embodiment in FIG. 1;

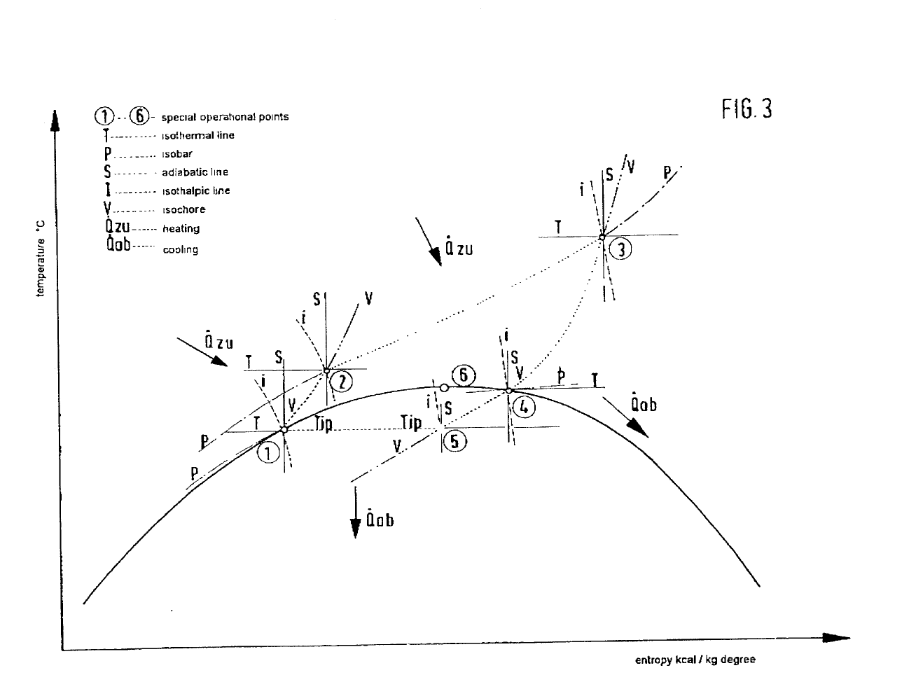

FIG. 3 a T-S diagram, which explains the process management;

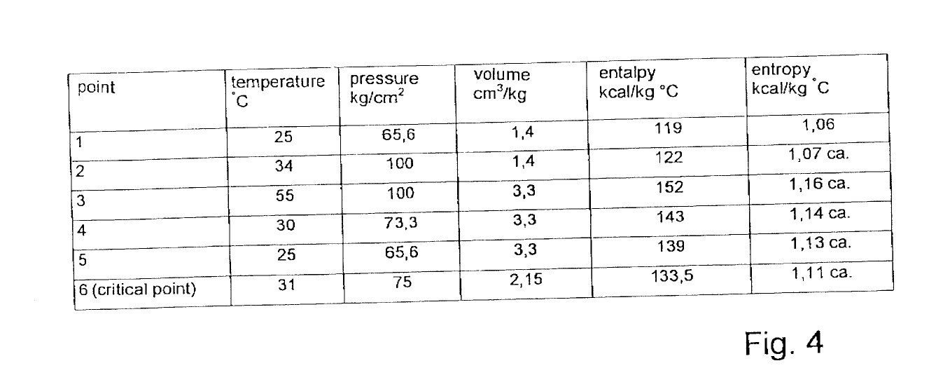

FIG. 4 the temperature, pressure, volume, enthalpy and entropy ratios at specific points from FIG. 3; and

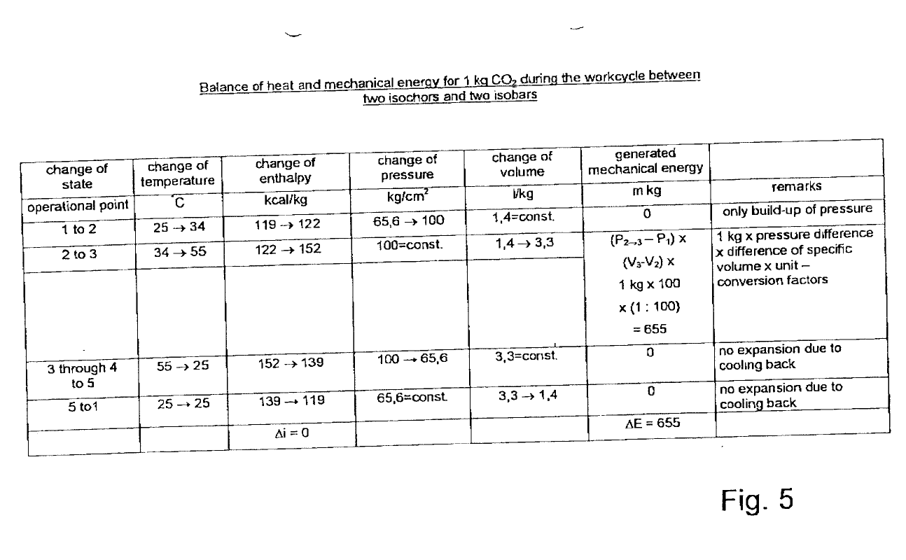

FIG. 5 an explanation of the individual working steps of the method of the invention as per FIG. 3.

FIG. 1 shows a reverse osmosis device according to the invention.

Here a solar collector 1 is connected via lines 3, 4 or 3′, 4′ to heat exchangers 2 or 2′. These heat exchangers are for their part connected in turn, via a supply line 9, 9′ and a discharge line 8, 8′ and a circulating pump 10, 10′, each to a working cylinder 5 or 5′, in which a lifting cylinder 7 or 7′ runs. The lifting cylinder 5, 5′ has an internal volume 6, 6′, which is filled with a pressure-condensed working medium at a critical temperature of between 20 and 100° C., here with CO₂ at a critical temperature of 31° C.

The working medium can now be heated via the solar collector 1 and the heat exchangers 2, 2′ in the cylinders 5, 5′ to temperature T₁ of the solar collector or practically to this temperature. In so doing it expands and pushes the respective lifting cylinder 7, 7′ outwards.

In the reverse manner, the working medium is led via lines 12, 13 and a circulating pump 14, or lines 12′, 13′ and circulating pump 14′ from the two working cylinders 6 or 6′ through heat exchangers 11, 11′. There it is cooled to a temperature T₂ of a heating bath 15 or 15′. The heat exchanger is for this purpose connected on its other side via lines 16, 16′ and 17, 17′ to heating baths 15, 15′.

It is now possible, therefore, in an isochronous manner through operation of the heat pumps 10 and 14′ to heat the working medium in the working cylinder 6 to temperature T₁ and simultaneously to cool the working medium in the working cylinder 6′ to temperature T₂. In a following step, the working medium can then be cooled in working cylinder 6 to temperature T₂ by operating circulating pump 14, and the working medium in working cylinder 6′ can be heated to temperature T₁ by operating circulating pump 10′. By this means, movement of the working pistons 7,7′ in the same direction is effected.

Between these two working pistons 7, 7′ is disposed a pump, connected via compensating devices 18, 18′, for example helical springs, which pump has a cylinder 19 with a double-acting pump piston 21. This pump piston 21 is now moved backwards and forwards by the movement in the same direction of working pistons 7,7′. A sealing ring 33 which is disposed in the middle of the piston 21 sub-divides the interior volume of the cylinder 19 into two partial volumes 20, 20′, which extend respectively on both sides of the sealing ring 33 in the direction of the to-and-fro motion of the piston 21. Each of these two volumes 20, 21 is connected via a suction line 23 to a salt water (SW) reservoir 22. The suction line can be led from the salt water reservoir 22 over a certain distance as a common suction line 23 before it is divided into two suction partial lines 23a and 23b which lead to the respective volumes 20, 20′. In each of the suction partial lines 23a, 23b is arranged a non-return valve 24, 24′ which prevents salt water from being able to flow out of the cylinder 19 back to the salt water reservoir 22.

Furthermore, the partial volumes 20, 20 are respectively connected via their own pressure line 27a, 27b, which lines are joined to form a common pressure line 27, to the conventional reverse osmosis device 26. This reverse osmosis device 26 is for example a module which has a semi-permeable membrane. The module has an outflow 30 on the pressure side to the semi-permeable membrane and an outflow 29 on the other side of the semi-permeable membrane to remove desalinated water (EW). Via outflow 30, salt-enriched salt water from the reverse osmosis device 26 can be discharged and guided back to the salt water reservoir 22, for example a sea.

In the partial lines 27a and 27b are also arranged non-return valves 28, 28′ which prevent salt water, pumped under pressure to the reverse osmosis device 26, from being able to flow back into the cylinder 19. If the pump piston 21 now moves to and fro in cylinder 19 in accordance with double arrow A, on a movement in the direction of cylinder 5 the salt water located in volume 20 is pressed under high pressure through line 27a, 27 to the reverse osmosis device 26. Simultaneously salt water is sucked into volume 20′ via line 23, 23b and the non-return valve 24′ from the salt water reservoir 22.

On the return movement of the pump piston 21 in direction of piston 5′, as a result of an expansion of the working medium in piston 5 and a contraction of the working medium in piston 5′, the salt water thus sucked up from the partial volume 20′ via lines 27b, 27 is pressed towards the reverse osmosis device 26. Simultaneously salt water is now sucked up from the reservoir 22 into partial volume 20 via line 23, 23a.

In order to meet the requirements of a rhythmically operating heat engine, the circulating pumps 10 and 14′ or respectively 14 and 10′ operate alternately. The working medium is heated in cylinder volumes 6, 6′ alternately to the temperature level T₁, or respectively cooled to the temperature level T₂. Here respectively one cylinder volume is heated to T₁ and the opposite cylinder volume to T₂. According to the physical characteristics of the working medium selected, in the region of the given boundaries in the T-S diagram expansion and contraction of the working medium occur in the rhythm of the heat supply and heat abstraction.

The expansion work takes place through heating of the working medium via circulating pump 10, 10′ and heat exchanger 2, 2′ to the temperature level T₁ whilst via circulating pump 14, 14′ the heating medium is brought by means of heat exchangers 11, 11′ to the temperature level T₂.

In returning to the lower temperature level T₂, no work is done. The useful work arises from the interplay from T₂ to T₁ with the maximum thermal efficiency η according to Carnot η=(T₁−T₂)/T₁.

However it should be pointed out here that the working medium in volumes 6, 6′ of cylinders 5, 5′ can of course also be guided via heat pumps acting in a piezoelectric manner, which control the heat flow direction according to the flow direction, or via Peltier elements between two temperatures T₁ and T₂. In this case, the solar plant 1 with the downstream heat exchangers 2, 2′, and the heating baths 15, 15′ with the pre-positioned heat pumps 11,11′ can be dispensed with.

FIG. 2 shows a further example of a device according to the invention, this one corresponding completely to that in FIG. 1 with deviations in the region of the working pistons 5, 5′. Here in FIG. 2 only the region of working piston 5 is represented, whilst naturally the region of working piston 5′ can be constructed in a corresponding manner. In all the figures the same or similar reference numerals refer to the same or similar components.

In contrast to FIG. 1, the heat exchangers 2 and 11 are now not directly connected to the interior volume 6 of working cylinder 5. For working cylinder 5 and its internal volume are connected via a line 32 to a supply reservoir 31 for the working medium. Now this reservoir is connected via lines 9, 8 or respectively 12 and 13 to heat exchangers 2 and 11. This results in heating or cooling of the working medium in the reservoir 31. Since the latter communicates however with the working medium in the internal volume 6 of working cylinder 5 via a line 32, a pressure increase and volume expansion in the reservoir 31 lead to a piston stroke of cylinder 5. What is critical here now is that the volume of the working medium can be so selected by means of reservoir 31 that in the boundaries from T₁ to T₂ or respectively T₂ to T₁, the volume change occurring produces the necessary piston path in coordination with the surface of piston 7. The cross-section of piston 7 is determined by the piston force necessary in each case.

In FIG. 2, therefore, the volume of the working medium is heated to T₁ and cooled to T₂ predominantly outside working cylinder 5 in reservoir 31 rhythmically via heat exchangers 2 and 11, such that the working stroke length can be determined by means of volume increase/reduction and effective piston surface to be any length, independently of the volume of cylinder 5.

FIG. 3 shows a T-S diagram for carbon dioxide as the working medium, the selected management of the cyclic process for FIGS. 1 and 2 being drawn in by a dotted line along the special operating points 1 to 5.

FIG. 4 and FIG. 5 show first of all the respective physical values of the operating medium at these points (FIG. 4) and the state alteration for the individual process steps according to the cyclic process as is represented in FIG. 3 (FIG. 5).

The following explanation is given by way of example with the aid of cylinder 5 from FIG. 1. Beginning with the working medium at a low temperature at point 1, there is an isochorous temperature increase from 25 to 34° C. from point 1 to point 2, the pressure rising from 65.6 kg/cm² to 100 kg/cm². In this process merely high pressure is built up. In the following step from point 2 to point 3, an isobaric temperature increase from 34 to 55° C. is carried out, the volume increasing from 1.4 l/kg to 3.3 l/kg. Here therefore a volume expansion takes place which leads to a stroke of the working piston 7. This piston stroke at a pressure of 100 kg/cm² leads to a compression of the salt water sucked in in the working cylinder 19 in chamber 20′ and discharge of this salt water at high pressure through line 27b in the direction of the reverse osmosis device 26.

Following point 3, isochorous cooling of the working medium from 55 to 25° C. is carried out, whereby the pressure also drops again to 65.6 kg/cm^{2.} This isochorous cooling takes place up to point 5, which is then followed by isothermal compression. Here the pressure of 65.6 kg/cm² remains constant, the temperature is 25° C. and compression ensues from 3.3 l/kg to 1.4 l/kg. Thus the working medium is again in its original state and piston 7 slides into its left-hand initial position. In this process, salt water is sucked into chamber 20′ through line 23b, 23 from the salt water reservoir 22. Now the next cycle can begin.

If both cylinders 5 and 5′ are guided in opposite directions in respect of the process management of operating point 1 to 3 or respectively 3 to 1, this results in a continuous to-and-fro pumping motion of the pump cylinder 19 and management of the entire application of pressure to the sucked-in salt water in the cyclic process.

What is claimed:

1. Device for carrying out reverse osmosis, operated by hydrostatic pressure, of a medium to be separated, having a conventional reverse osmosis device (26) with a pressure side and a product side, which are both separated by a semi-permeable membrane, and wherein the medium to be separated can have pressure applied to it on the pressure side by means of a pressure generation appliance (5, 7, 19, 21, 5′, 7′), characterised in that the pressure generation appliance (5, 7, 19, 21, 5′, 7′) contains a pressure-condensed working medium with a critical temperature of between 20 and 100° C., in which a pressure increase and volume increase can be generated by heating to apply to the medium to be separated.

2. Device according to claim 1 characterised in that the pressure generation appliance (5, 7, 19, 21, 5′, 7′) comprises a heat engine, in which the working medium can be guided in a cyclic process between a lower temperature T₂ and a higher temperature T₁.

3. Device according to claim 1, characterised in that the pressure generation appliance (5, 7, 19, 21, 5′, 7′) is connected to a solar collector (1) in order to heat the working medium to temperature T₁.

4. Device according to claim 1, characterised in that the pressure generation appliance (5, 7, 19, 21, 5′, 7′) is connected to a medium at temperature T₂ in order to cool the working medium to temperature T₂.

5. Device according to claim 1, characterised in that the working medium is heated and/or cooled by means of a piezoelectric heat pump or a Peltier element.

6. Device according to claim 1, characterised in that the pressure generation appliance (5, 7, 19, 21, 5′, 7′) comprises a pump (19, 21) which is connected on the suction side to a reservoir (22) for the medium to be separated, and on the discharge side to the reverse osmosis device (26).

7. Device according to claim 6, characterised in that the pump (19, 21) comprises a pump cylinder (19) with a double-acting pump piston (21), the interior space of the pump cylinder (19) being connected on both sides of the pump piston (21) respectively to the reservoir (22) for the medium to be separated and to the reverse osmosis device (26).

8. Device according to claim 7, characterised in that the double-acting pump piston (21) is connected on each of its two sides to a working piston (7, 7′) of a working cylinder (5, 5′) and can be moved by same, the working cylinders (5, 5′) being filled with the working medium.

9. Device according to claim 8 characterised in that the double-acting pump piston (21) is connected on each of its two sides via respectively one compensating device (18, 18′) to the respective working pistons (7, 7′) of the respective working cylinder (5, 5′).

10. Device according to claim 9, characterised in that the compensating device (18, 18) is a spring member, for example a helical spring.

11. Device according to claim 8, characterised in that the working cylinders (5, 5′) are respectively connected to a storage container (31) for the working medium.

12. Device according to claim 8, characterised in that the working cylinders (5, 5′) and/or the storage containers (31) for the working medium are connected each to two heat exchangers (2, 2′, 11, 11′) in such a way that the working medium in each working cylinder (5, 5′) and/or in the storage container can be brought in one of the heat exchangers (2, 2′) to temperature T₁ and in the other heat exchanger (11, 11′) to temperature T₂.

13. Device according to claim 12, characterised in that each of the heat exchangers (2, 2′) is connected via a ring line to the solar collector (1) and the medium at temperature T1 can flow through the solar collector (1) and the heat exchangers (2, 2′).

14. Device according to claim 12, characterised in that a medium at temperature T₂ can flow through each of the heat exchangers (11, 11′) via a ring line.

15. Device according to claim 1, characterised in that there is disposed between the pressure generation appliance (5, 7, 19, 21, 5′, 7′) and the reverse osmosis device (26) an air vessel (25) for the medium to be separated.

16. Device according to claim 1, characterised in that heat can be supplied to the working medium at between 20° C. below the medium's critical temperature and 40° C. above said critical temperature.

17. Device according to claim 1, characterised in that heat can be supplied to the working medium at between 10° C. below the medium's critical temperature and said critical temperature.

18. Device according to claim 1, characterised in that the working medium contains chlorotrifluoromethane, carbon dioxide, ethane, acetylene, nitrogen(II) oxide, methyl fluoride, hydrogen chloride and/or bromotrifluoromethane.

19. Method for carrying out reverse osmosis operated by hydrostatic pressure, wherein the medium to be separated is supplied under pressure to the pressure side of a semi-permeable membrane in a reverse osmosis device (26), characterised in that, to generate the pressure, a pressure-condensed working medium with a critical temperature of between 20 and 100° C. is heated up, a pressure increase and volume increase of the working medium being generated and
the pressure of the working medium so produced being applied to the medium to be separated.

20. Method according to claim 19, characterised in that the working medium is guided in a cyclic process between a lower temperature T₂ and a higher temperature T1.

21. Method according to claim 19, characterised in that the heat for heating the working medium is generated by means of a solar collector (1) and transferred to the working medium.

22. Method according to claim 21, characterised in that the working medium, after it has been heated up, is cooled to temperature T₂.

23. Method according to claim 19, characterised in that the working medium is heated and/or cooled by means of a piezoelectric heat pump and/or a Peltier element.

24. Method according to claim 19, characterised in that the pressure and volume increase generated by the working medium as it is heated up drives a pump (19, 21) which sucks up the medium to be separated and conveys it under pressure to the reverse osmosis device (26).

25. Method according to claim 19, characterised in that the medium to be separated is pumped by means of a pump (19, 21) having a pump cylinder (19) with a double5 acting pump piston (21), the pump cylinder (19) sucking up in one stroke on its one side medium to be separated and on the other side discharging sucked-up medium to be separated, and on its return path on the one side discharges the sucked-up medium to be separated and on the other side sucks up medium to be separated.

26. Method according to claim 25, characterised in that the double-acting pump piston (21) is moved in its two directions respectively by means of a working piston (7, 7′) of a working cylinder (5, 5′), the working cylinders (5, 5′) being filled with the working medium.

27. Method according to claim 20, characterised in that the working medium is brought by means of a first heat exchanger to temperature T₁ and/or by means of a second heat exchanger to temperature T₂.

28. Method according to claim 19, characterised in that the working medium is heated to a temperature of between 20° C. below its critical temperature and 40° C. above its critical temperature.

29. Method according to claim 28, characterised in that the working medium is heated to a temperature of between 10° C. below its critical temperature and said critical temperature.

30. Device according to claim 19, characterised in that chlorotrifluoromethane, carbon dioxide, ethane, acetylene, nitrogen(II) oxide, methyl fluoride, hydrogen chloride and/or bromotrifluoro-methane is used as the working medium.

31. Use of a device or a method according to claim 1 for the desalination of water especially of sea water, and for obtaining fresh water, especially drinking water.
